(19) United States
(12) Patent Application Publication
(10) Pub. No.: US 2016/0148600 A1
(43) Pub. Date: May 26, 2016

(54) Locking string-end for musical instruments

(71) Applicant: Kamran Salehi, Roselle, IL (US)

(72) Inventor: Kamran Salehi, Roselle, IL (US)

(21) Appl. No.: 14/329,988

(22) Filed: Jul. 14, 2014

(51) Int. Cl. G10D 3/10

(52) U.S. Cl. CPC G10D 3/10

(57) ABSTRACT

The disclosed locking string-end for musical instruments is an elongated string-end which is attached to the string in half of its length. After passing the elongated string-end through holes in the bridge and the tuning post, the string is bent at the point it is attached to the string-end to about 90 degrees, forming a “T” shaped end with the top part of the “T” being longer than the diameter of the hole in the tuning peg, preventing the string from coming out of the tuning peg hole, thus locking the string in place for tuning.

### BACKGROUND AND BENEFITS OF THE INVENTION

This invention relates to musical instrument strings having one or more string-end termination elements.

The conventional musical instrument strings have two major issues from user's perspective; 1:They are time consuming to change since the tuning peg needs to be turned many times so that there are enough turns of the string around the peg to prevent the string from slipping from the peg, losing its tension. 2:When a new string is installed, since the first few turns of the string around the tuning peg are not made under full tension of the string, they partially slip as the instrument is played so several re-tunings are required before the instrument's tuning becomes stable. The disclosed invention addresses both of those issues by providing a string-end which after passing through the peg hole can be locked to the peg so that numerous turns of string around the peg are not required.

In many applications, the other side of the string may have a conventional ball end which locks the string to the bridge. By proposing an elongated string-end with a diameter smaller than the holes in bridge and tuning post of the instrument, and length of string-end larger than the diameter of those holes, this present invention offers a string design that can be locked in place from both ends.

Although this invention is applicable to majority of stringed instruments, there is a particular interest in electric guitar players community to have locking strings. There has been a number of tuning machines which provide a locking system for the string. However, since these locking tuning machines are more expensive, the majority of guitars do not include them. The present invention can be used with conventional non-locking tuning mechanisms which include only a hole in the tuning peg for string attachment. So majority of players can benefit from this invention.

There has been other inventions closely related to the present one, but each have had some draw backs that prevented them from being widely used by players to address the objectives of this invention. A summary of those follows:

In patent EP0120363 A2, Roger Siminoff proposed a string-end which has a diameter approximately equal to the diameter of the hole in instrument's tuning peg. While this design is appropriate for some instruments, or instruments designed specifically to use such a string, the holes in majority of existing bridges are too small in diameter to allow passing a string-end with the approximate diameter of the hole in the tuning mechanism. In other words, in most existing instruments, the holes for strings in bridges are smaller than the holes in tuning pegs. Also, many bridges such as tremolo types, have a relatively complex path for the strings which will not allow passing a string-end with the approximate diameter of the holes in the tuning pegs.

In Patents EP0806757 A2, and U.S. Pat. No. 3,881,236 A, string-ends are described, but these types of string-ends are designed not to pass through holes in bridges. So they do not accomplish the objective of locking both ends of the string to the instrument.

### BRIEF SUMMARY OF THE INVENTION

The disclosed locking string-end for musical instruments is an elongated string-end which is attached to the string in half of its length. The other end of the string, may have a normal ball end for attachment to the bridge. Alternatively, both ends of a string may have the type of elongated string-end described here. After passing the elongated string-end through holes in the bridge and the “tuning peg” or “tuning post”, the string is bent at the point it is attached to the string-end to about 90 degrees, forming a “T” shaped end with the top part of the “T” being longer than the diameter of the hole in the tuning peg, preventing the string from coming out of the tuning peg hole, thus locking the string in place for tuning. This locking mechanism provides more stable tuning and the string can be changed faster than conventional strings since considerably less turns of the string around the tuning peg are required.

### BRIEF DESCRIPTION OF FIGURES

FIG. 1: Shows the proposed elongated string-end.

FIG. 2: Shows the elongated string-end attached to a string, prior to bending the string.

FIG. 3: Shows the elongated string-end attached to a string, after bending the string.

FIG. 4: Shows the string-end and a tuning peg, after the string has been bent.

FIG. 5: Shows a variation of string-end, with a slot for crimping the string-end.

### DETAILED DESCRIPTION

It is highly desirable to have a string-end which can pass with the string through holes in the instrument's bridge or tuning mechanism and then with a simple operation such as bending the string, prevent the string-end from passing through the instrument's holes again. This eliminates the need for laborious tasks such as either turning the tuning pegs multiple times, or tying knots at the end of the string as it is traditionally done in case of classical type guitar bridges. The present invention provides a type of string-end with such a capability and it can be used with many varieties of strings and instruments.

Some variations of this invention are described here using figures, however the scope of this invention covers other varieties which share the same basic principal. All variations and permutations of features are not described here since it would unnecessarily extend the text. The essence of this invention lies in that the elongated string-end can pass through string holes in the instrument when it is parallel to the string lengthwise, and when the string is bent around the mid-point of the string-end, the length of the string-end being longer than diameter of the holes it has passed through, prevents it from passing again, providing an easy method of attaching strings to instruments.

The diagrams described below help to clarify the disclosed invention, as examples.

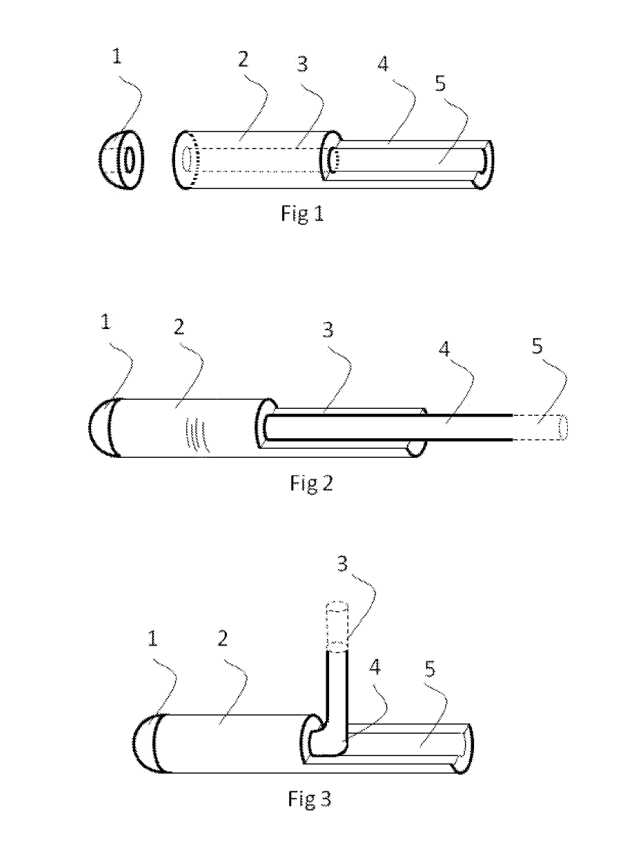

FIG. 1 depicts elongated string-end. In this figure;

1 is a rounded tip to facilitate insertion of the string-end into holes. Although the tip is depicted as a separate part to clarify the design. It may be produced as an attached integral portion with the rest-of the string-end. The rounded tip may include a hole for the string to pass through.

2 is the cylindrical portion of the string-end.

3 is an elongated hole for the string to be positioned in. Diameter of this hole should be slightly larger than the diameter of the string to allow inserting the string into it.

4 is portion of the string-end shaped in form of a half cylinder where about half of the cylinder is removed lengthwise.

5 is a cavity for the string to be placed in.

FIG. 2 depicts elongated string-end attached to a string, prior to bending the string. In this figure;

1 is a rounded tip to facilitate insertion of the string-end into holes.

2 is the cylindrical portion of the string-end.

3 is portion of the string-end shaped in form of a half cylinder where about half of the cylinder is removed lengthwise.

4 is the string shown as attached to the string-end. These two parts may be attached in a variety of ways including;

A—Spot welding at the tip of the string-end.

B—Soldering at the tip of the string-end.

C—Dipping the string in an adhesive before inserting it into the string-end. Or alternatively, passing the string through the hole in the string-end so that the tip of the string extends beyond the string-end, then dipping the tip of the string in adhesive material, and retracting it back into the string-end so that the adhesive cements it in place.

D—Reducing the internal diameter of the hole in the string-end after string is placed inside it by extrusion, crimping, or pressing the string-end.

E—Casting the string-end around the string using a mold.

The string-end may be made from different materials based on the specific type of instrument it is intended for including; metals, alloys, or hard plastics or other synthetic material.

5 Drawn with dotted lines represents the rest of the string.

FIG. 3 depicts elongated string-end attached to a string, after bending the string. In this figure;

1 Is the rounded tip of the string-end.

2 Is the cylindrical portion of the string-end.

3 Represents the rest of the string.

4 Is the point where the string is bent.

5 Is the cavity where the string resided in before it was bent.

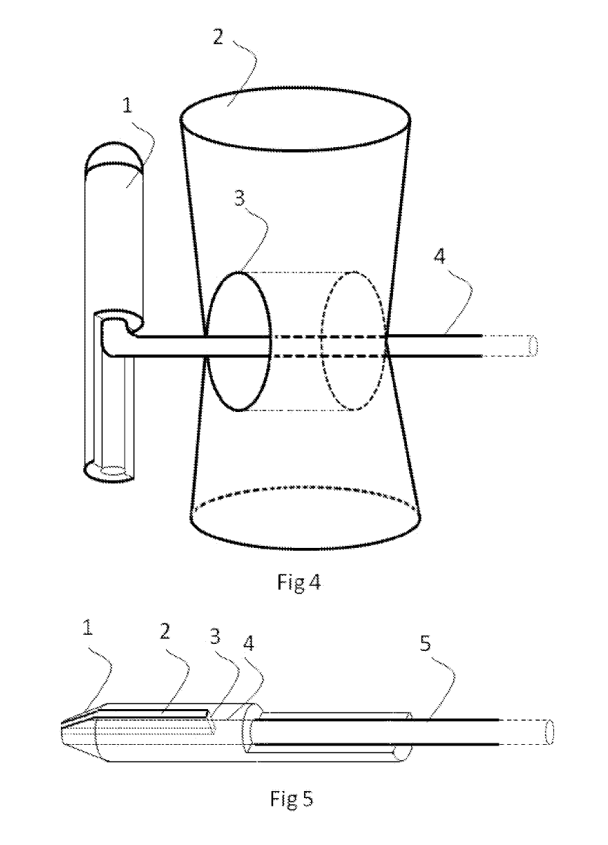

FIG. 4 depicts the string-end and a tuning peg, after the string has been bent. In this figure;

1 Is the string-end.

2 Is the top portion of a conventional tuning peg or tuning post of a tuning machine.

3 Is the hole in the tuning peg where the string end is passed through it before bending the string. Then string is bent to prevent the string-end from passing through the hole again. In effect, the string is locked in place.

4 Is the rest of the string.

### PREFERRED EMBODIMENT

A version of this invention is presented here by way of example as a preferred embodiment. As mentioned before, variations of this invention may be more appropriate for a given instrument or type of string. All of which share the same basic design principals. So this version should not be interpreted as in any way limiting the scope of the invention.

FIG. 5 depicts a variation of string-end, with a slot for crimping the string-end. In this figure;

1 Is the tip of the string-end.

2 Is a slot which in the diagram extends from the tip to more than half way in the cylindrical portion of the string-end. This slot may in fact extend all the way through the entire length of the cylindrical portion as another variation of the design.

3 Shows the part of the slot not viable with dotted lines.

4 Is the hole in the string-end for the string to be placed in.

5 Is the string before it is bent.

If the slot (2) is extended along the entire length of the cylindrical portion, then the entire string end may be produced by putting an appropriately shaped flat sheet of metal, and the string, in a press equipped with a mold (or die) of the finished desired shape of the string-end.

1- An elongated string-end attached to a musical instrument string where approximately half of the said string-end lengthwise is attached to and encases the string, where the rest of the length of said string-end extending towards the center of the string is not attached to the string, but is initially positioned alongside and parallel to the string, allowing the string to be bent in the area close to the half point length of the said string-end, after the string is passed through the holes in the instrument's bridge and tuning mechanism in order to prevent the string from becoming detached from the tuning post, or the bridge.

2- A string-end as in claim 1, where tip of the string-end is rounded or sharpened to allow easy threading through an instrument's bridge and tuning mechanism holes.

3- A string-end as in claim 1, with a slot cut-out along the length of the string-end to facilitate attachment of the string-end to the string by crimping or pressing the string-end.

4- A string-end as in claim 1, where string is attached to the string-end by means of soldering.

5- A string-end as in claim 1, where string is attached to the string-end by means of welding.

6- A string-end as in claim 1, where string is attached to the string-end by means of adhesives.

7- A string-end as in claim 1, where string is attached to the string-end by means of extrusion.

8- A string-end as in claim 1, where string is attached to the string-end by means of casting the string-end around the string.

9- A string-end as in claim 1, where string is attached to the string-end by means of swaging.
